(19) United States
(12) Patent Application Publication
(10) Pub. No.: US 2026/0001459 A1
(43) Pub. Date: Jan. 1, 2026

(54) TRIM COVER ASSEMBLY AND SEAT ASSEMBLY

(71) Applicant: LEAR CORPORATION, Southfield, MI (US)

(72) Inventors: Wenjuan YANG, Shanghai (CN); Yao ZHANG, Shanghai (CN); Yong YANG, Shanghai (CN); Jiajun LI, Shanghai (CN); Chandrashekar SIMHA, Shanghai (CN)

(73) Assignee: LEAR CORPORATION, Southfield, MI (US)

(21) Appl. No.: 19/250,553

(22) Filed: Jun. 26, 2025

(30) Foreign Application Priority Data
Jul. 1, 2024 (CN) 202421539906.6

(51) Int. Cl. B60N 2/58

(52) U.S. Cl. CPC B60N 2/5825

(57) ABSTRACT

A trim cover assembly and a seat assembly are described. A trim cover assembly is provided with a trim panel with a first trim member connected to a second trim member via a first join, and a third trim member connected to the second trim member via a second join. The trim cover assembly has one or more first retaining trim members connected to an inner surface of the trim panel adjacent to or via the first join, with each first retaining trim member extending outwardly therefrom to an associated first free distal end; and one or more second retaining trim members connected to the inner surface of the trim panel adjacent to or via the second join, with each second retaining trim member extending outwardly therefrom to an associated second free distal end. A retainer is supported by and extends between the first and second free distal ends.

### CROSS-REFERENCE TO RELATED APPLICATIONS

This application claims priority to Chinese utility model application No. 202421539906.6 filed Jul. 1, 2024, the disclosure of which is hereby incorporated in its entirety by reference herein.

### TECHNICAL FIELD

This relates to a trim assembly for a vehicle seat assembly, and a method of forming the trim assembly.

### BACKGROUND

A seat assembly, such as a vehicle seat assembly, may be provided with a trim assembly. Examples of a trim assembly and vehicle seat assembly may be found in U.S. Patent Publication No. 2024/0067066, U.S. Patent Publication No. 2021/0316614, U.S. Pat. Nos. 10,682,935, and 10,144,320.

### BRIEF DESCRIPTION OF THE DRAWINGS

FIG. 1 illustrates a perspective view of a vehicle seat assembly;

FIG. 2 illustrates a seat member for use with the vehicle seat assembly of FIG. 1 according to an embodiment;

FIG. 3 illustrates a perspective view of a trim cover assembly for use with the vehicle seat assembly of FIG. 1 and the seat member of FIG. 2 according to an embodiment;

FIG. 4 illustrates a partial schematic view of the trim cover assembly of FIG. 3;

FIG. 5 illustrates a schematic view of a retaining trim member for use with the trim cover assembly of FIG. 4; and

FIG. 6 illustrates a partial sectional schematic view of the trim cover assembly of FIG. 3.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

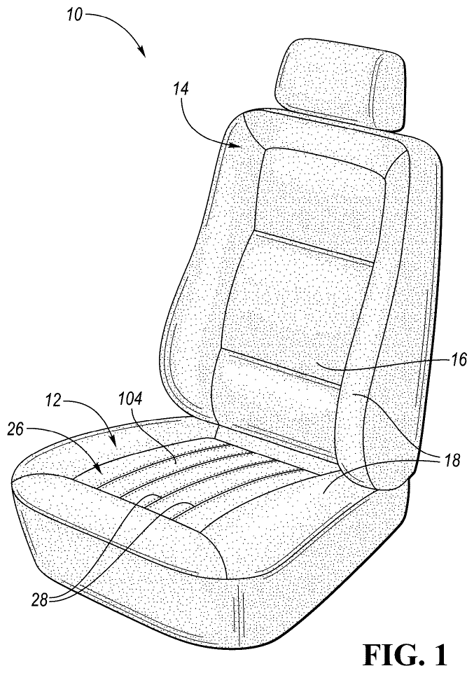

FIG. 1 illustrates a seat assembly 10, such as a vehicle seat assembly 10. In various examples, the seat assembly 10 may be shaped and sized as a front row driver or passenger seat, a second, third, or other rear row seat, and may include bench-style seats as shown, bucket seats, or other seat styles. Furthermore, the seat assembly may be a non-stowable seat or a stowable seat that may be foldable and stowable in a cavity in the vehicle floor. Additionally, the seat assembly 10 may be configured for use with other non-vehicle applications.

The seat assembly 10 has first and second seat members 12, 14, such as a seat base 12 and a seat back 14, respectively, that cooperate to form a seating surface 16 for a vehicle occupant. It is contemplated that the seat back 14 may be omitted in some applications, such as when the seat assembly 10 is configured as a stool. The seat members 12, 14 may each be supported via a support surface that is provided by a frame and/or a substrate, which may be formed from stamped steel alloy, a fiber reinforced polymer, or any suitable structural material. The seat base 12 may be sized to receive a seated occupant to support a pelvis and thighs of the occupant. The seat back 14 may be sized to extend upright from the seat base 12 to support a back of the occupant. The seat assembly may additionally have a head restraint (not shown). The seat base 12 and the seat back 14 may be moveable relative to one another to provide adjustments for the seat assembly.

The vehicle seat assembly 10 of FIG. 1 is illustrated as being covered with at least one trim cover assembly 18. The trim assembly 18 provides the trim surface, or visible surface or A surface of the seat assembly 10.

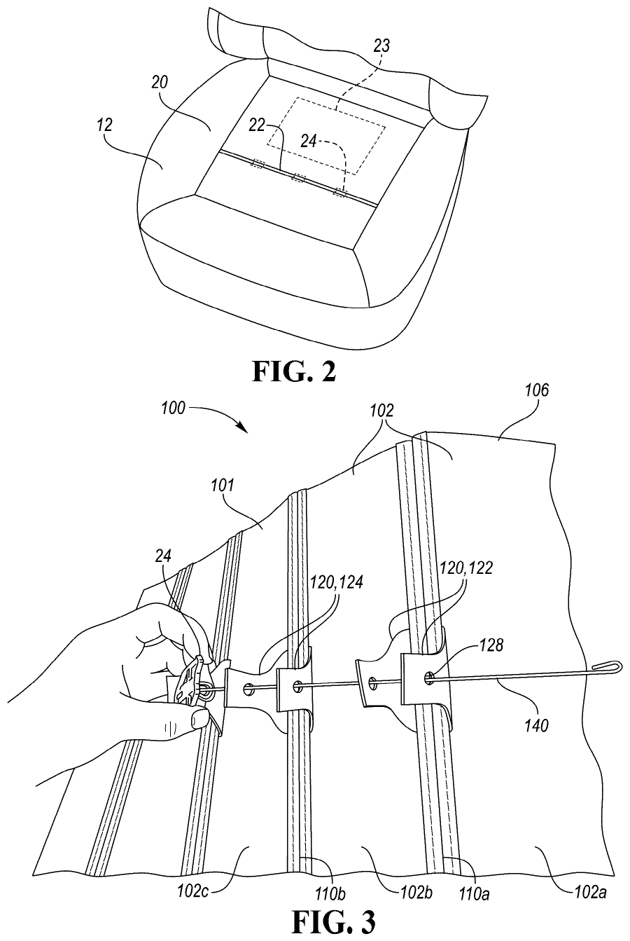

FIG. 2 illustrates an embodiment of a cushion 20 for a seat member for use with the vehicle seat assembly of FIG. 1 by way of example, and in the example shown, the seat member is a seat base 12, and is illustrated as being uncovered or without the trim cover assembly 18. The disclosure may likewise be applied to a seat back 14. Each of the seat members 12, 14 include a substrate or frame structure, cushioning 20, and trim covering.

As shown in FIG. 2, the seat member 12 includes a cushion material 20. In one example, the cushion 20 is provided by a foam material, such as a molded urethane foam, or the like. In other examples, other cushion materials are provided, including non-foam materials. The cushion 20 may be further formed from a combination of materials, including foam and/or non-foam materials. The cushion 20 may be provided with one or more grooves 22 or trenches extending at partially across the seating surface side of the cushion and seat member. The grooves 22 may each extend transversely across the seat member, longitudinally along the seat member, in another direction, or a combination thereof. Furthermore, the grooves may be linear, curved, and/or another shape. In the non-limiting example shown in FIG. 2, a single groove 22 extends laterally on the seat member. In other examples, the cushion 20 may have multiple grooves 22 that are spaced apart from one another. The groove 22 placement may be limited to a specified location or region on the seat member based on other components 23 within the seat member, such as a massager, fan, sensors, or the like.

The trim cover assembly 18 may be provided by one or more assemblies or pieces that are attached to the underlying seat member 12, 14 using fastener(s) 24, also referred to as second retainer(s) 24. The trim assemblies 18 may be fastened or anchored to the vehicle seat member 12, 14 into the grooves 22 using the second retainers 24. The second retainers 24 may be positioned within the groove 22 to connect to the trim assembly and first retainer as described below. The second retainers 24 may be provided by clips embedded into the cushion 20, a wire and hog ring assembly, or the like. Trim assemblies 18 according to various examples of the present disclosure and for use with a seat assembly such as seat assembly 10 are described below in greater detail.

The disclosed trim assembly 18 and method may be used with a seat back 14, a seat base 12 or both. For simplicity, a trim assembly and a method associated with the trim assembly is described with respect to use with a seat base 12 by way of example; however, the trim assembly and method may likewise be applied to use with a seat back 14, with a seat back and base in combination, or with another vehicle component or other seating device requiring a trim cover.

In the examples described herein, the trim cover assembly 18 extends over the seating surface of the seat back member 14. As such, the trim assembly 18 may extend over one or more grooves 22 in the seat member. These grooves 22 are used to anchor the trim assembly 18 to the underlying seat member 14 and prevent sagging, bagginess, looseness, floating, tenting, or the like of the trim assembly 18, e.g. when it extends over a large surface area. In some examples, and as shown herein, the seating surface of the trim assembly 18 may be provided with a pattern 26 as described below and as shown in FIG. 1 by way of example, and the pattern may be formed by join(s) 28 such as seams between the members of the trim cover assembly, decorative stitching into a panel such as via quilting, or a combination thereof. As used herein, a join 28 may be formed by sewing, welding, lamination, bonding, or another technique.

In the examples shown, the pattern 26 for the trim cover assembly 18 is unaligned with the grooves 22 in the underlying seat member, or is diverse from the grooves 22. As used herein, unaligned means that at least portions of the pattern 26, e.g., the join 28, in the trim assembly is angled relative to the associated groove 22. The groove 22 may not be able to be aligned or oriented with the desired pattern 26, for example, based on the components 23 within the seat member.

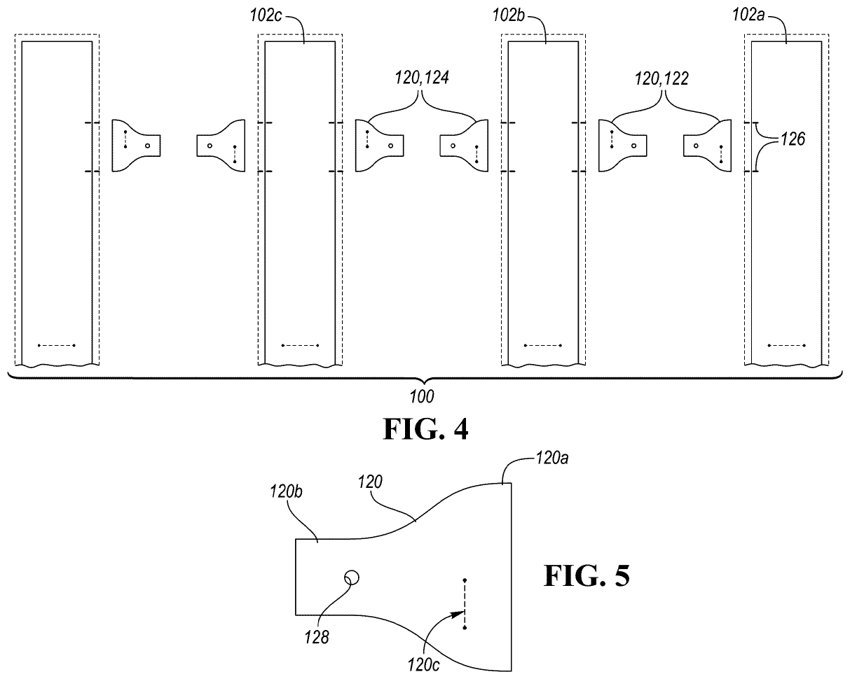

Referring to FIGS. 3-6, a trim cover assembly 100 is shown and described for use with the seat member 12 of FIG. 2 and the vehicle seat assembly of FIG. 1. The trim cover assembly 100 may be provided as trim cover assembly 18.

The trim cover assembly 100 is formed from a trim panel 101 with multiple trim members 102. The trim panel 101 has a first outer surface 104 (also with reference to FIG. 1) and a second inner surface 106. The first outer surface 104 forms the finished surface, or A-surface for the trim assembly 100 and is an outer face for the trim assembly when installed on the seat member. The second inner surface 106 is the inner surface and faces or is in contact with the cushion 20 of the seat member when installed on the seat member.

The trim panel 101 may be formed from multiple trim members 102 that are joined together, with each trim member 102 joined to an adjacent trim member 102 via an associated join 110 as described above. In the example shown, adjacent trim members 102 are joined to one another via a join 110 as a seam that is sewn to connect the adjacent trim members, although other joins 110 are also contemplated. The joins may be straight, curved, and/or other complex shape. In the example shown, the first and second trim members 102a,b are connected by a first join 110a, the second and third trim members 102b,c are connected by a second join 110b, and so forth to form the panel 101.

Each trim member 102 may be formed from fabric, such as fabrics used in vehicle interiors, and includes leather, leatherette or faux leather, vinyl, woven cloth or fabric, non-woven cloth or fabric, knitted fabric, and the like. Each trim member 102 may further have one or more layers such that it is formed by a laminate with a fabric outer layer and an inner foundation layer of a three-dimensional spacer material, foam, multi-knit, or the like. The fabric outer layer and foundation layer may be connected as a laminate, e.g. via a hot lamination process, flame lamination process, tack-sew process, or the like.

The trim assembly 100 additionally has retaining trim members 120. In the example shown, the retaining trim members 120 are provided by first retaining trim members 122 and second retaining trim members 124. The first and second retaining trim members 122, 124 may each be provided by an associated pair of retaining trim members, as shown in a wing configuration as a pair of retaining trim members positioned opposite to one another across an associated join 110, or may be provided by a single retaining trim member at each associated join. Each join 110 may be provided with one or more associated retaining trim members 120, or only selected joins 110 may be provided with retaining trim members 120. The retaining trim members 120 may be formed from a nonwoven fabric or material, fleece, an elastic material, or the like.

The retaining trim members 122, 124 are described as follows with reference to retaining trim member 120. Each retaining trim member 120 is formed with a proximal end 120a and a distal end 120b, with an intermediate region 120c therebetween. The proximal end 120a is aligned with an edge of the one of the trim members 102 adjacent to a join 110. An edge of the one or more of the trim members 102 may be provided with one or more registrations 126 such as a notch, other mark or indicator, to align with the proximal end 120a of the retaining trim member.

The proximal end 120a of the retaining trim member may be connected to the trim panel 101 via the join 110. The proximal end 120a of the retaining trim member may alternatively or additionally be connected to the trim panel 101 via another join 130, also referred to as a secondary join 130, third join or fourth join herein, which may be provided by a seam such as a join seam, French seam, decorative seam, or the like. In some examples, the secondary join 130 may be visible from the outer surface 104 of the trim panel 101 and trim assembly 100.

The first retaining trim members 122 are connected to the inner surface 106 of the trim panel 101 adjacent to or via the first join 110a, with each first retaining trim member extending outwardly therefrom to an associated first free distal end 122a. The first retaining trim members 124 are connected to the inner surface 106 of the trim panel 101 adjacent to or via the second join, each first retaining trim member extending outwardly therefrom to an associated second free distal end 124a.

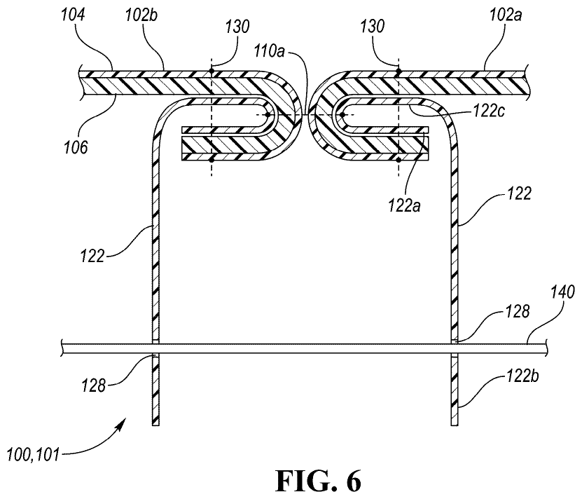

For example, and as shown in FIG. 6, each first retaining trim member 122 is connected to the trim panel 101 via the first join 110a and also connected to the first or second trim members 102a,b via an associated secondary join or third join 130. The secondary joins 130 are directly adjacent to the first join 110a. As shown, the secondary join 130 connects to the associated retaining trim member 120 at two different locations: the proximal end 122a and an intermediate region 122c is spaced apart from the proximal end 122a and the distal end 122b.

The second retaining trim members 124 are likewise connected to the trim panel 101 via the second join 110b and/or connected to the second or third trim member via an associated secondary join 130 or fourth join, with the fourth join 130 directly adjacent to second join 110b.

The proximal end 120a may be wider that the associated distal end 120b, for example, to aid in aligning and joining the proximal end 120a of the retaining trim member to the panel 101, and to reduce the material at the distal end 120b that is received into the groove 22 of the cushion 20.

The distal ends 122a, 124a of the retaining trim members are each formed with a an aperture 128 therethrough, e.g. with the distal ends 122a of the first retaining trim members 122 formed with a first aperture 128, and the distal ends 124a of the second retaining trim members 124 formed with a second aperture 128.

A retainer 140 is supported by and extends between the distal ends 120b of the retaining members, e.g. between distal ends 122b and 122b. The retainer 140 may extend across trim members 102 and at least partially across the panel 101. The retainer 140 may be positioned to be unaligned with the joins 110 between the trim members 102 of the panel 101, and aligned with the groove 22 for receipt therein. The retainer 140 may therefore be positioned at a non-zero angle, e.g. perpendicular or other acute or obtuse angle, relative to each of the joins 110. The groove 22 is therefore positioned at a non-zero angle relative to each of the joins 110 when the trim cover assembly 100 is attached to the seat member.

In the example shown, the retainer 140 is provided by a wire or rod that is received through the apertures 128. The retainer 140 may be straight as shown, or may be provided with a curved or other complex shape to match the shape of the groove 22. The wire as a retainer 140 may be received by the fasteners 24 in the seat member, e.g. received by the clips 24 or connected to a wire 24 via hog rings, or the like. The ends of the wire retainer 140 may be bent or folded over, and contact the ends of the groove 22 when the retainer 140 is installed into the seat member to limit transverse movement of the retainer 140 relative to the seat member.

A method according to the present disclosure is provided to assemble the trim assembly, and assemble the seat assembly, and may be used with the seat assembly 10 of FIG. 1, the seat members of FIG. 2, and the trim assemblies 18, 100 as described herein. In various examples, various steps in the method may be omitted, added, rearranged into another order, or performed sequentially or simultaneously. A trim assembly and a seat assembly as formed via the method below are also contemplated in conjunction with the description provided above.

A first trim member 102a is connected to a second trim member 102b and one or more first retaining trim members 122 via a first join 110a. The second trim member 102b is connected to a third trim member 102c and one or more second retaining trim members 124 via a second join 110b.

One of the first retaining trim members 122 is connected to one of the first and second trim members 102a, 102b via a third join 130 adjacent to the first join 110a. One of the second retaining trim members 124 is connected to one of the second and third trim members 102b, 102c via a fourth join 130 adjacent to the second join 110b.

A retainer member 140 is supported via distal free ends 120b of the first and second retaining trim members 122, 124 such that the retainer member 140 is unaligned with the first join 110a and the second join 110b.

The retainer member 140 is positioned into a groove 22 of a seat member, and the retainer member 140 is connected to the seat member.

Clause 1. A trim cover assembly in combination with, or without, any one or more of the successive clauses, comprises a trim panel comprising a first trim member connected to a second trim member via a first join, and a third trim member connected to the second trim member via a second join, wherein the trim panel comprises an outer surface and an inner surface. The trim cover assembly further comprises one or more first retaining trim members connected to the inner surface of the trim panel adjacent to or via the first join, with each first retaining trim member extending outwardly therefrom to an associated first free distal end; and one or more second retaining trim members connected to the inner surface of the trim panel adjacent to or via the second join, with each second retaining trim member extending outwardly therefrom to an associated second free distal end. The trim cover assembly further comprises a retainer supported by and extending between the first and second free distal ends.

Clause 2. The trim cover assembly of any of the preceding or successive clauses wherein each first free distal end comprises a first aperture therethrough, each second free distal end comprises a second aperture therethrough, and the retainer comprises a wire received by the first and second apertures.

Clause 3. The trim cover assembly of any of the preceding or successive clauses wherein the retainer is positioned at a non-zero angle relative to each of the first and second joins.

Clause 4. The trim cover assembly of any of the preceding or successive clauses wherein a proximal end of each first retaining trim member is wider than the associated first free distal end.

Clause 5. The trim cover assembly of any of the preceding or successive clauses wherein a proximal end of each first retaining trim member is aligned with an edge of the respective one of the first and second trim members adjacent to the first join.

Clause 6. The trim cover assembly of any of the preceding or successive clauses wherein the edge of the respective one of the first and second trim members further comprises one or more registrations to align the first retaining trim member.

Clause 7. The trim cover assembly of any of the preceding or successive clauses wherein each first retaining trim member is connected to the trim panel via the first join and/or each second retaining trim member connected to the trim panel via the second join.

Clause 8. The trim cover assembly of any of the preceding or successive clauses wherein each first retaining trim member is connected to the trim panel via the first join and also connected to the first or second trim member via an associated third join, and each second retaining trim member is connected to the trim panel via the second join and also connected to the second or third trim member via an associated fourth join.

Clause 9. The trim cover assembly of any of the preceding or successive clauses wherein the third join directly adjacent to first join, and fourth join directly adjacent to second join.

Clause 10. The trim cover assembly of any of the preceding or successive clauses wherein the third join is connected to the proximal end of the first retaining trim member and an intermediate region of the first retaining trim member is spaced apart from the proximal end.

Clause 11. The trim cover assembly of any of the preceding or successive clauses wherein the one or more first retaining members comprises a pair of first retaining members positioned opposite to one another across the first join, and wherein the one or more second retaining members comprises a pair of second retaining members positioned opposite to one another across the second join.

Clause 12. The trim cover assembly of any of the preceding or successive clauses wherein each of the first and second joins comprises a seam.

Clause 13. The trim cover assembly of any of the preceding or successive clauses wherein each of the first, second and third trim members comprise a first layer, each first layer comprising a leather, a leatherette, a vinyl, a knitted fabric, and/or a woven fabric.

Clause 14. The trim cover assembly of any of the preceding or successive clauses wherein each of the first, second, and third trim members further comprise a second foundation layer attached to the first layer.

Clause 15. The trim cover assembly of any of the preceding or successive clauses wherein each of the first and second retaining trim members comprise a nonwoven material.

Clause 16. A seat assembly further comprising a seat member comprising a groove extending at least partially across the seat member; and the trim cover assembly of any of the preceding or successive clauses, wherein the retainer is received within the groove to connect the trim cover assembly to the seat member.

Clause 17. The seat assembly according to any of the preceding or successive clauses further comprising one or more second retainers positioned within the groove to connect to the retainer.

Clause 18. The seat assembly according to any of the preceding or successive clauses wherein the groove is positioned at a non-zero angle relative to each of the first and second joins when the trim cover assembly is attached to the seat member.

Clause 19. A trim cover assembly with, or without, any one or more of the successive clauses, comprising a trim panel comprising a first trim member connected to a second trim member via a first join, and a third trim member connected to the second trim member via a second join. The trim cover assembly further comprises a pair of first retaining trim members connected to the trim panel via the first join, with each first retaining trim member extending outwardly from the trim panel to a respective first distal end, and with each first distal end comprising a first aperture; and a pair of second retaining trim members connected to the trim panel via the second join, with each second retaining trim member extending outwardly from the trim panel to a respective second distal end, and with each second distal end comprising a second aperture. The trim cover assembly further comprises a wire retainer extending through the first and second apertures to be supported by the first retaining trim members and the second retaining trim members, the retainer extending across the second trim member.

Clause 20. The trim cover assembly of any of the preceding or successive clauses wherein each first retaining trim member is also connected to the first or second trim member via a respective secondary join adjacent to the first join.

Clause 21. A method with, or without, any one or more of the successive clauses, comprising connecting a first trim member, a second trim member, and one or more first retaining trim members via a first join; and connecting the second trim member, a third trim member, and one or more second retaining trim members via a second join. The method further comprises connecting one of the first retaining trim members to one of the first and second trim members via a third join adjacent to the first join, and connecting one of the second retaining trim members to one of the second and third trim members via a fourth join adjacent to the second join. The method further comprises supporting a retainer member via distal free ends of the first and second retaining trim members such that the retainer member is unaligned with the first join and the second join.

Clause 22. The method with, or without, any one or more of the successive clauses, further comprising positioning the retainer member into a groove of a seat member, and connecting the retainer member to the seat member.

Clause 23. Any one of the preceding clauses 1-22 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A trim cover assembly comprising:
a trim panel comprising a first trim member connected to a second trim member via a first join, and a third trim member connected to the second trim member via a second join, wherein the trim panel comprises an outer surface, and an inner surface;
one or more first retaining trim members connected to the inner surface of the trim panel adjacent to or via the first join, each first retaining trim member extending outwardly therefrom to an associated first free distal end;
one or more second retaining trim members connected to the inner surface of the trim panel adjacent to or via the second join, each second retaining trim member extending outwardly therefrom to an associated second free distal end; and
a retainer supported by and extending between the first and second free distal ends.

2. The trim cover assembly of claim 1 wherein each first free distal end comprising a first aperture therethrough; and each second free distal end comprising a second aperture therethrough, and the retainer comprising a wire received by the first and second apertures.

3. The trim cover assembly of claim 1 wherein a proximal end of each first retaining trim member is wider than the associated first free distal end.

4. The trim cover assembly of claim 1 wherein a proximal end of each first retaining trim member is aligned with an edge of the respective one of the first and second trim members adjacent to the first join.

5. The trim cover assembly of claim 1 wherein each first retaining trim member is connected to the trim panel via the first join and/or each second retaining trim member connected to the trim panel via the second join.

6. The trim cover assembly of claim 1 wherein each first retaining trim member is connected to the trim panel via the first join and also connected to the first or second trim member via an associated third join; and each second retaining trim member is connected to the trim panel via the second join and also connected to the second or third trim member via an associated fourth join.

7. The trim cover assembly of claim 1 wherein the one or more first retaining trim members comprises a pair of first retaining trim members positioned opposite to one another across the first join; and
wherein the one or more second retaining trim members comprises a pair of second retaining trim members positioned opposite to one another across the second join.

8. A seat assembly further comprising:
a seat member comprising a groove extending at least partially across the seat member; and
the trim cover assembly of claim 1, wherein the retainer is received within the groove to connect the trim cover assembly to the seat member.

9. The seat assembly of claim 8 further comprising one or more second retainers positioned within the groove to connect to the retainer.

10. The seat assembly of claim 8 wherein the groove is positioned at a non-zero angle relative to each of the first and second joins when the trim cover assembly is attached to the seat member.
